(19) United States
(12) Patent Application Publication
(10) Pub. No.: US 2007/0223494 A1
(43) Pub. Date: Sep. 27, 2007

(54) Method for the resolution of addresses in a communication system

(75) Inventors: Altti Hyyrynen, Vantaa (FI); Janne Korkeila, Hyvinkaa (FI); Patrick Hoving, Helsinki (FI); Mikko Kuikka, Jyvaskyla (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/471,679

(22) Filed: Jun. 21, 2006

(30) Foreign Application Priority Data
Mar. 21, 2006 (FI) 20060266

(51) Int. Cl. H04L 12/56

(52) U.S. Cl. 370/395.54; 370/409

(57) ABSTRACT

The invention relates to a method for address resolution in a communication system. Each node is configured with a management node physical address. A node assuming the role of a management node transmits a known management node physical address to a via a network segment. The management node physical address is associated with the network segment in the switch. Address resolution queries are unicasted from other nodes to the switch using the management node physical address. The switch relays the queries to the network segment of the management node. From the queries the management node records logical address and physical address pairs pertaining to other nodes.

### BACKGROUND OF THE INVENTION

1. Field of the Invention

The invention relates to addressing of communication system nodes. Particularly, the invention relates to a method for the resolution of addresses in a communication system.

2. Description of the Related Art

The Ethernet has established its dominance as the technology for local area networking. The vast majority of local area networks for offices are based on Ethernet equipment and cabling. Sometimes Ethernet is even used in such environments as factories, for example, for the control of robots on assembly lines and for the control of chemical equipment. Logically, an Ethernet essentially consists of a medium, which is shared by a number of communicating stations. In practice, the medium is a coaxial cable to which the stations are physically attached via a transceiver. The Ethernet is defined in the Institute of Electrical and Electronic Engineers (IEEE) standard 802.3. The Ethernet standard comprises two link level sub-layers, namely, a Medium Access Control (MAC) sub-layer and Logical Link Control (LLC) sub-layer on top of it.

The MAC protocol on the MAC sub-layer encapsulates a Service Data Unit (SDU) from the LLC by adding a 14 byte Protocol Control Information (PCI) header before the data and by appending a 4-byte (32-bit) Cyclic Redundancy Check (CRC) after the data. The MAC frame is preceded by an 8-byte preamble, which is used for the synchronization of the receiver clock to the transmitter clock. The preamble consists of a sequence of a single bit value (0 or 1) followed by a sequence of the complement of the value. When encoded using Manchester encoding, at 10 Mbps, the 62 alternating bits produce a 5 MHz square wave. It should be noted that the pattern 11 is used to mark the last two bits of the preamble. The transition moment between the single bit value sequences and the measurement of the single bit value sequence durations allow the receiver to determine the proper local clock speed and phase. The local clock speed corresponds to the duration of a bit from the receiver perspective. The phase corresponds to the phase of the waveform, which is matched against the received waveform to determine each received bit value. The MAC frame is preceded also by a small 9.6 microsecond (μS) idle period (the minimum inter-frame gap). When this is received, the Ethernet receive interface starts collecting the bits into bytes for processing by the MAC layer.

Reference is now made to FIG. 1, which illustrates an Ethernet MAC frame in prior art. The MAC frame comprises a 6-byte destination address 100. The first bit indicates whether the destination address is a single recipient address in compliance with the unicast mode, a group address recognized by a group of recipient nodes in compliance with the multicast mode, or all recipient nodes connected to the medium in compliance with the broadcast mode. A 6-byte source address 101 is set to the globally unique node address of the sender. The source address may be used by the network layer protocol to identify the sender, but usually other mechanisms are used such as an address resolution protocol. The main function of the source address is to allow address learning, which is used to configure the filter tables in bridged and switches. A 2-byte type field 102 provides a Service Access Point (SAP) to identify the type of protocol encapsulated in the MAC frame. For example, the value 0×0800 is used to identify the Internet Protocol (IP). Other values are used to indicate other network layer protocols such as AppleTalk and X.25. In the case of IEEE 802.3 LLC, this may also be used to indicate the length of the data part. There is also a data part 103 consisting of 46-1500 bytes that carry a MAC SDU received from an upper layer protocol, typically, the LLC. A 4-byte CRC 104 added at the end of the frame provides error detection in the case where line errors or transmission collisions result in corruption of the MAC frame. The receiver discards a frame with an invalid CRC without further processing. The MAC protocol does not provide any indication that a frame has been discarded due to an invalid CRC.

Reference is now made to FIG. 2, which illustrates a prior art network comprising four Ethernet segments, to which a number of workstations are connected, an Ethernet switch and a router. In FIG. 2 there are four Ethernet segments, namely segment 210, segment 220, segment 230 and segment 240. There is also an Ethernet switch 200. Ethernet switch 200 comprises four ports, namely port 201, port 202, port 203 and port 204. Ethernet segments 210, 220, 230 and 240 are connected to ports 201, 202, 203 and 204 with intermediate cables 201A, 202A, 203A and 204A, respectively. The intermediate cables may be, for example, drop cables, which connect to the Ethernet segments, for example, using MAC transceivers e.g. Attachment Unit Interfaces (AUI). Connected to Ethernet segment 210 there are three workstations, namely workstations 211, 212 and 213. Workstation 213 is connected to Ethernet segment 210 using a drop cable 213A. Similarly, the other workstations are also connected to their respective Ethernet segments using a drop cables or other similar hardware. Connected to Ethernet segment 220 there are three workstations namely workstations 221, 222 and 223. Connected to Ethernet segment 230 there are three workstations namely workstations 231, 232 and 233. However, connected to Ethernet segment 240 there is a router 241. Router 241 is connected to Ethernet segment 240 via drop cable 241A. The drop cable is connected to a port 250 within router 241. In router 241 there are also ports such as ports 252 and 254, which are used to connect the router to other local area networks or other wide area networks. The other networks are not shown in FIG. 2. They are not required for the purposes of the illustration of the relevant background art.

Reference is now made to FIG. 3, which illustrates the functioning of the Address Resolution Protocol (ARP) in the network of FIG. 2 in prior art. The ARP is defined in the Internet Engineering Task Force (IETF) document RFC 826. In FIG. 3 workstation 231 wishes to send a data packet to workstation 211. It is assumed that workstation 231 knows the IP address or other equivalent layer-3 address associated with workstation 211. In order to discover the MAC address of workstation 211 workstation 231 issues an address resolution protocol query message, which is encapsulated in a MAC frame. In the MAC frame the destination address is the MAC broadcast address. The source address is the MAC address of workstation 231. The MAC address of workstation 231 is specific to the LAN adapter connected to workstation 231. The address resolution protocol query message indicates an IP address, for which the owner workstation must return its MAC address. As illustrated with arrow 300, Ethernet switch 200 receives in port 203 the address resolution protocol query message encapsulated in a MAC frame. Due to the fact that the destination address in the MAC frame is the broadcast address, Ethernet switch 200 must transmit the MAC frame from all other ports connected to Ethernet switch 200 that is, the ports 201, 202 and 204. It should be noted that there is no reason for Ethernet switch 200 to repeatedly transmit the received MAC frame from port 203 since this MAC frame was already transmitted in the very same Ethernet segment 230 by workstation 231. The simultaneous transmission of the MAC frames encapsulating the address resolution protocol query message by Ethernet switch 200 is illustrated with arrows 301A, 301B and 301C. The reception of the MAC frame in workstation 211 via its Ethernet adapter is illustrated with arrow 301D. The MAC frame is actually received by all nodes connected to any of the Ethernet segments illustrated in FIG. 3 because the destination address in the MAC frame was the broadcast address. Each workstation inspects the IP address contained in the address resolution protocol query message and checks whether it matches the IP address currently held by that workstation. Since only workstation 211 holds an IP address that matches the IP address provided in the address resolution protocol query message, it is the only workstation that prepares a reply message. As illustrated with arrow 302, workstation 211 provides an address resolution protocol response message encapsulated in a MAC frame comprising as the source address the MAC address of workstation 211. The MAC frame is received to port 201 in Ethernet switch 200. Ethernet switch 200 checks the MAC layer destination address and it determines that the MAC layer destination address is currently associated with port 203. Therefore, Ethernet switch 200 transmits the MAC frame encapsulating the address resolution protocol response message via port 203, as illustrated with arrow 303. Workstation 231 recognizes its MAC layer address from the destination address of the MAC frame and receives the address resolution protocol response message. Due to the fact that the message is the address resolution protocol response message, workstation 231 extracts the source address from the MAC frame and thereby is able to record the MAC address corresponding to the IP address, with which the address resolution protocol response message was associated.

There may be a problem associated with the solution illustrated in FIG. 3 and generally with Ethernet in relying on broadcasting in address resolution. The use of broadcasting may easily choke a time-critical network, especially in a start-up phase where a number of computers connected to the network are powered on or rebooted substantially simultaneously. This may introduce intolerable delays. Therefore, a mechanism that occupies less the shared media may be beneficial. It may be useful to avoid the transmitting of frames in segments in which the destination node is not located.

### SUMMARY OF THE INVENTION

The invention relates to a method for address resolution in a communication system comprising at least a switch, a first network segment, a second network segment, a first node and a second node. The method comprises configuring a management node physical address in said first node and said second node; said first node detecting that it must act as a management node; transmitting said management node physical address from said first node to said switch via said first network segment; associating said management node physical address with said first network segment in said switch; transmitting an address resolution query message from said second node via said second network segment to said switch, said message comprising said management node physical address, a logical address of said second node and a physical address of said second node; said switch transmitting said address resolution query to said first network segment; said first node recording an association between said logical address of said second node and the physical address of said second node; and said first node providing to said second node information on at least one association between a physical address and a logical address.

The invention relates also to a system comprising a first node configured to store a management node physical address, to detect that it must act as a management node, to transmit said management node physical address to a switch via a first network segment, to record an association between a logical address of a second node and the physical address of said second node, and to provide to said second node information on at least one association between a physical address and a logical address; said switch configured to associate said management node physical address with said first network segment and to transmit an address resolution query to said first network segment; said second node configured to store a management node physical address, to transmit said address resolution query message via a second network segment to said switch, said message comprising said management node physical address, a logical address of said second node and a physical address of said second node.

The invention relates also to a network node comprising a memory configured to store a management node physical address, and a processor configured to detect that said network node must act as a management node, to transmit said management node physical address via a network segment, to receive an address resolution query message, to record in said memory an association between a logical address of a second node and the physical address of said second node from said address resolution query message, and to provide from said memory to said second node information on at least one association between a physical address and a logical address in response to said address resolution query message.

The invention relates also to a network node comprising a memory configured to store a management node physical address, and a processor configured to transmit an address resolution query message via a network segment, said message comprising said management node physical address as a unicast destination address, a logical address of the network node and a physical address of the network node, to receive information on at least one association, each said association comprising a physical address and a corresponding logical address and to record in said memory said information on said at least one association.

The invention relates also to a network node comprising means for storing a management node physical address; means for detecting that said network node must act as a management node; means for transmitting said management node physical address via a network segment; means for receiving an address resolution query message; means for recording in said memory an association between a logical address of a second node and the physical address of said second node from said address resolution query message, means for providing from said memory to said second node information on at least one association between a physical address and a logical address in response to said address resolution query message.

The invention relates also to a network node comprising: means for storing a management node physical address; means for transmitting an address resolution query message via a network segment, said message comprising said management node physical address as a unicast destination address, a logical address of the network node and a physical address of the network node; and means for receiving information on at least one association, each said association comprising a physical address and a corresponding logical address; and means for recording in said memory said information on said at least one association.

The invention relates also to a computer program comprising code adapted to perform the following steps when executed on a data-processing system: storing a management node physical address; detecting the need to assume the role of a management node; transmitting said management node physical address via a network segment; receiving an address resolution query message; recording an association between a logical address of a node and the physical address of said node from said address resolution query message; and providing information on at least one association between a physical address and a logical address in response to said address resolution query message.

The invention relates also to a computer program comprising code adapted to perform the following steps when executed on a data-processing system: reading a management node physical address from a memory of a network node; transmitting an address resolution query message via a network segment, said message comprising said management node physical address as a unicast destination address, a logical address of the network node and a physical address of the network node; receiving information on at least one association, each said association comprising a physical address and a corresponding logical address; and recording in the memory of the network node said information on said at least one association.

In one embodiment of the invention, the first node is a system management node, that is, a computer node that performs system management related tasks. The system management node may be, for example, an address register node, which provides mapping information for the mapping of logical network addresses or logical names to physical layer addresses at the request of other nodes. In one embodiment of the invention, the second node is a computer node, which acts in a normal mode wherein it does not perform at least part of the tasks of a system management node.

In one embodiment of the invention, the address resolution query message does not specify any logical addresses for which a corresponding physical address is requested in the response message from the first node to the second node. Instead, the first node merely returns a number of pairs, each comprising a logical address and physical address, that it has collected so far from similar address resolution queries. In one embodiment of the invention, the address resolution query message specifies a logical address for which a corresponding physical address is requested in the response message from the first node to the second node.

In one embodiment of the invention, there is a third node connected to a network segment that is further connected to the switch. The third node is configured to check periodically the status of said first node. The periodical checking is performed, for example, by means of periodic polling of the first node. The third node is configured to detect a failure of said first node, for example, from the failure of the first node to reply to a polling message sent to it by the third node. The third node or any other node aware of the failure of the first node selects a fourth node to become a management node in place of the failed first node. The third node may participate in the selection process and may get selected to become the management node.

The node that performed the selection may request the fourth node to enter a management node state. The third node may also assume the role of the management node. Thus, the third node itself may enter the management node state. In the management node state the fourth node may perform the tasks of the first node as explained hereinbefore.

In one embodiment of the invention, there is a maintenance unit, which is configured to determine that said first node is to become a system management node and to request said first node to enter a management node state. The maintenance unit performs this at the start of the entire system. The maintenance unit comprises, for example, a user interface, via which a system administrator may manually configure a given node within the system to be the system management node. The determination of the system management node may also be performed based on configuration information read from a secondary memory. The system administrator may also assign other nodes to become ordinary nodes, which enquire the system management node for the translation of logical addresses to physical addresses. The configuration data provided via a management unit to a given node is stored in the memory of each node within the system. The maintenance unit may also be the system management node itself.

In one embodiment of the invention, the first node is configured to read a configuration memory to check whether it must enter a management node state. The configuration memory may be a random access memory or a secondary memory. The configuration memory may be a part of the memory of the first node that is used for other purposes. The configuration memory may also be a flash memory.

In one embodiment of the invention, the first and the second network segments are Ethernet segments, the switch is an Ethernet switch and said physical address is a Medium Access Control (MAC) address.

In one embodiment of the invention, the first or the second network segment comprises a wireless network segment supported by a number of transceivers, for example, one connected to the first or the second node and another connected to the switch. In one embodiment of the invention, said system is comprised in a blade server and said first node, that is, the system management node, and second node are computer units within said blade server. Computer units within a blade server are sometimes called blades. Such a computer unit comprises at least one processor, at least one memory and an interface for communicating with other computer units within the blade server. Sometimes there may also be a hard drive or other similar non-volatile memory in a computer unit. Such computer units may be added, replaced and removed from the blade server. A computer unit may have a single processor in it or a number of processors. A processor within the computer unit may also comprise a number of cores. The processor may be, for example, a dual core processor. In case of a multi-processor computer unit, the processors within the computer unit are configured to share at least part of memory of the computer unit.

In one embodiment of the invention, the logical address is a logical name identifying a computer unit within a network element comprising at least two computer units. In one embodiment of the invention, the logical address is an address on the Open System Interconnection layer 3. In one embodiment of the invention, the logical address is an Internet Protocol (IP) address. In one embodiment of the invention, the physical address is a link layer address.

In one embodiment of the invention, the network element comprises at least one of a Global System of Mobile Communications network element and a Universal Mobile Telephone System network element.

In one embodiment of the invention, the network element comprises at least one of a Mobile Switching Center, Mobile Switching Center Server, a Call State Control Function (CSCF) and a Radio Network Controller (RNC).

In one embodiment of the invention, the system comprises a local are network, for example, an Ethernet or a Wireless Local Area Network (WLAN).

In one embodiment of the invention, the computer program is stored on a computer readable medium. The computer readable medium may be a removable memory card, magnetic disk, optical disk or magnetic tape.

In one embodiment of the invention, each node in the system is configured with a management node physical address. A node assuming the role of a management node transmits a known management node physical address via a network segment to at least one switch. The management node physical address is associated with the network segment in the switch. Address resolution queries are unicasted from other nodes to the switch using the management node physical address. The switch relays the queries to the network segment of the management node. From the queries the management node records logical address and physical address pairs pertaining to other nodes.

The benefits of the invention may be related to, for example, improved efficiency of the system, higher performance, reduced utilization of the network media, increased capacity and reduced delays in the exchanging of messages between nodes within the network.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram that illustrates an Ethernet MAC frame in prior art;

FIG. 2 is a block diagram, which illustrates a prior art network comprising four Ethernet segments, to which a number of workstations are connected, an Ethernet switch and a router;

FIG. 3 is a block diagram, which illustrates the functioning of the Address Resolution Protocol (ARP) in the network of FIG. 2 in prior art;

FIG. 4 is a block diagram illustrating a system applying the method for the resolution of addresses in one embodiment of the invention;

FIG. 5 is a message sequence chart illustrating the supervision and the changing of a primary address register node in one embodiment of the invention;

FIG. 6 is a flowchart illustrating a method for address resolution in one embodiment of the invention;

FIG. 7 is a flowchart illustrating a method for supervising a primary address register node and performing a switchover from a primary address register node to a secondary address register node in one embodiment of the invention; and

FIG. 8 is a block diagram illustrating an address register node in one embodiment of the invention; and

FIG. 9 is a block diagram illustrating a computer node in one embodiment of the invention.

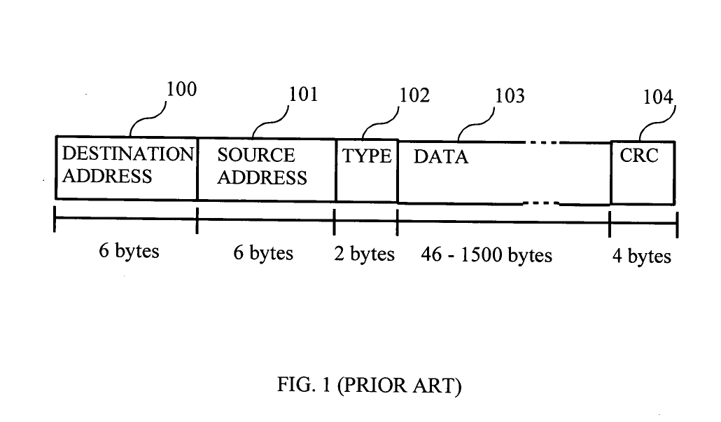

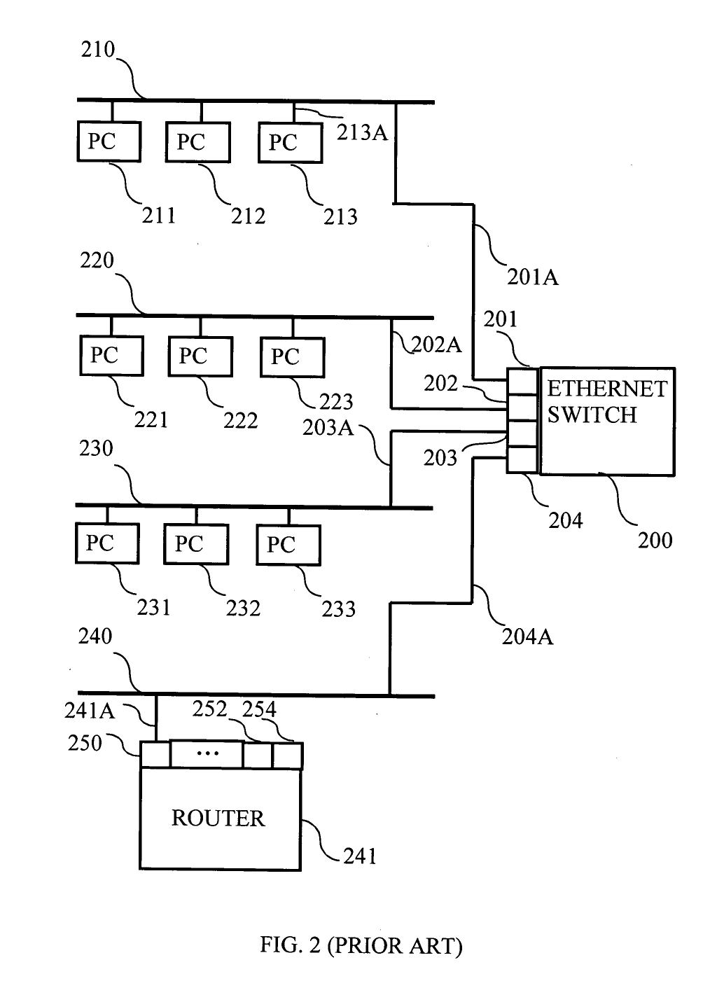

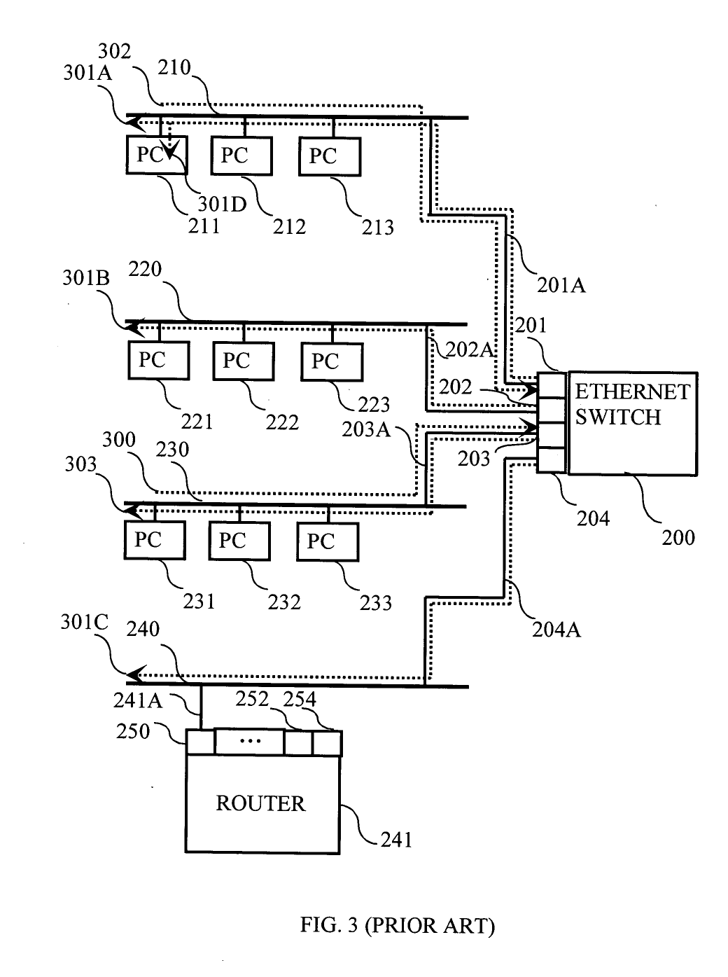

### DETAILED DESCRIPTION OF EMBODIMENTS

Reference will now be made in detail to embodiments of the present invention, examples of which are illustrated in the accompanying drawings.

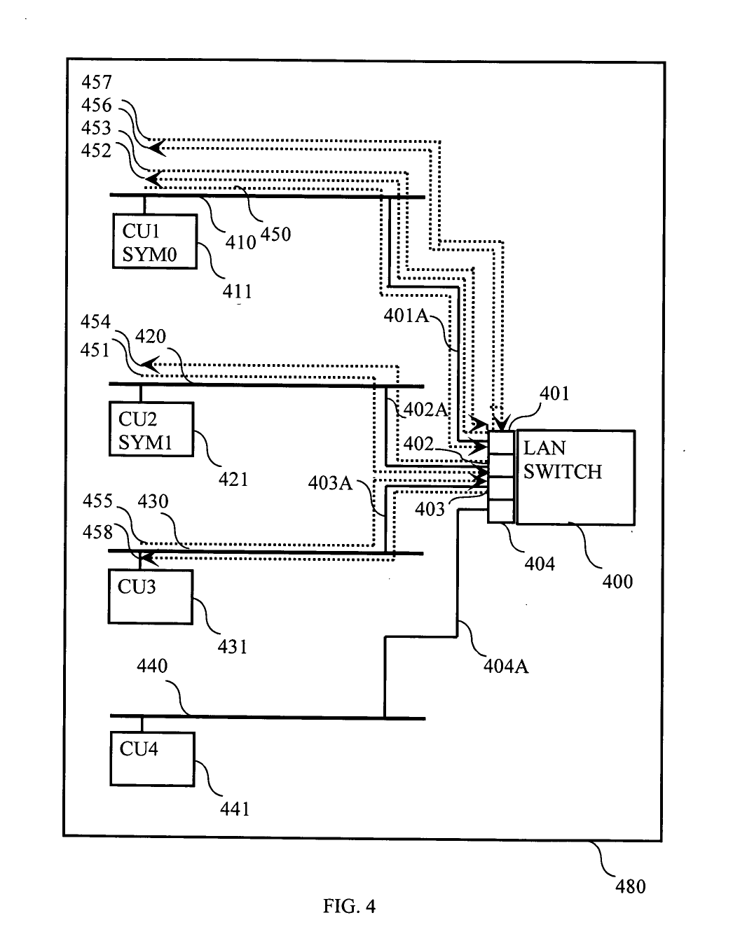

FIG. 4 is a block diagram illustrating a system applying the method for the resolution of addresses in one embodiment of the invention.

In FIG. 4 there are four local area network segments, which are, for example, Ethernet segments or WLAN segments comprised in a system 480, which is, for example a blade server, a multi-unit computer system or just a communication network. There are LAN segments 410, 420, 430 and 440. Connected to LAN segments 410, 420, 430 and 440 there are computer units 411, 421, 431 and 441, respectively. There is LAN switch 400 which has associated with it four ports, namely ports 401, 402, 403 and 404. These ports are connected to LAN segments 410, 420, 430 and 440 with drop cables 401A, 402A, 403A and 404A respectively. Computer unit 411 is designated as a primary system management node. For example computer unit 421 is designated as a secondary system management node. A primary system management computer unit, in other words a primary system management node, is in charge of address register node functionalities. A system management node acts as an address register node. Hereinafter, the term system management node refers to the primary system management node, unless otherwise stated.

The starting point in FIG. 4 is that the system has been restarted and no computer has knowledge of the MAC addresses of any other computer. However, a single computer within the system, more precisely, the system management node, has been configured with a predefined unique system management node physical address for the receiving of MAC frames. Such an address is hereinafter called the management node physical address for brevity. The management node physical address has also been configured in advance in all the other computer units that have a need to communicate with the system management node. The management node physical address has also been configured in the computer units that are backup units for the primary computer unit.

For example, in order to obtain a translation table for the mapping of computer unit logical names to physical address, the other computer units transmit MAC frames wherein the destination address field consists of the management node physical address. First, computer 411 detects that it has been assigned the role of the primary system manager node. Thereupon, it transmits a MAC frame to LAN switch 400 as illustrated with arrow 450. In the MAC frame the source address consists of the management node physical address. In that way, LAN switch 400 learns the LAN segment, which is currently hosting the system management node. In case MAC frames are received, which indicate as the destination address management node physical address, it is only necessary to transmit the MAC frames to LAN segment 410, from which the primary system management node advertised its presence by means of the MAC frame 450.

Thereafter, it is assumed that computer unit 421 performs startup. Computer unit 421 transmits a second MAC frame to LAN switch 400, as illustrated with arrow 451. The destination address in the second MAC frame is the management node physical address. As illustrated with arrow 452, LAN switch 400 transmits the second MAC frame in LAN segment 410 as a third MAC frame. Thereupon, computer unit 411 receives the third frame. In one embodiment of the invention, the third MAC frame encapsulates an upper layer protocol message wherein computer 421 announces its existence to system management node 411. As a response, system management node 411 transmits a fourth MAC frame as illustrated with arrow 453 to LAN switch 400. As illustrated with arrow 454, LAN switch 400 transmits a fifth MAC frame via port 402 to LAN segment 420. The MAC frame illustrated with arrow 454 comprises an upper protocol layer message, which provides information on each computer unit that has thus far registered its logical name and MAC layer address to system manager node 411 and therein in the address register functionality. However, in FIG. 4 the table for the mapping of logical names to MAC addresses received by computer unit 421 is empty because thus far no other computer unit has made its registration to system manager node 411.

Thereupon, computer unit 431 performs a system startup procedure, for example, booting. As illustrated with arrow 455, computer unit 431 sends a sixth MAC frame LAN switch 400. In the MAC frame the destination address is the system management node physical address. The sixth MAC frame is transmitted by LAN switch 400 from port 401 to LAN segment 410 as the seventh MAC frame, as illustrated with arrow 456. From the seventh MAC frame system management node 411 detects its own MAC address, that is, the unique management node physical address as the destination address. From the upper layer protocol information system management node extracts the logical name for computer unit 431. It associates the logical name of computer unit 431 with the MAC address provided in the source address field of the seventh MAC frame. The system management node registers in its memory the pair formed by the logical name and the MAC address of computer unit pair. As illustrated with arrow 457, system management node 411 sends an eight MAC frame to LAN switch 400. LAN switch 400 transmits the eight MAC frame as the ninth MAC frame in LAN segment 430, as illustrate with arrow 458. Computer unit 431 receives the ninth MAC frame. From the upper layer protocol information carried in the ninth MAC frame computer unit 431 is able to obtain a list of logical name and MAC address pairs associated with each computer that have thus far registered to system management node 411. By means of predefined computer booting order it is possible to optimize the message exchanges with system management node 411 so that the logical name and MAC address pairs are received by via computers in correct order. This means that a first computer wishing to communicate with a second computer must ensure that the second computer has been rebooted before the first computer.

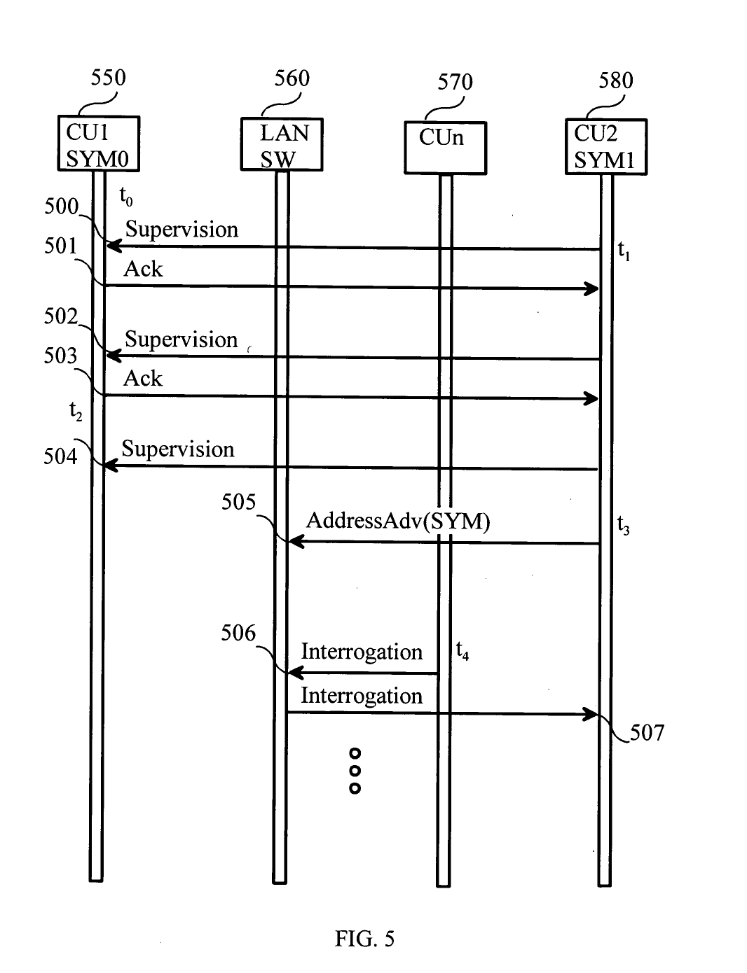

FIG. 5 is a message sequence chart illustrating the supervision and the changing of a primary address register node in one embodiment of the invention. In FIG. 5 there are three computer units namely computer unit 550, computer unit 570 and computer unit 580. There is also a LAN switch 560. At time to, computer unit 550 is in the role of the system management node. It maintains the address register. On the contrary, at that time computer unit 580 is in the role of the secondary system management node. The secondary system management node supervises the primary system management node 550. The supervision comprises that the secondary system management node periodically checks that the primary system management node is functional and responds to supervision messages. Therefore at time t₁ computer unit 580 issues a supervision message to computer unit 550 as illustrated with arrow 500. At that time computer unit 550 is up and running and is able to respond to the supervision request. Therefore, it acknowledges the supervision to computer unit 580, as illustrated with arrow 501. Later computer unit 580 issues a second supervision message to computer unit 550, as illustrated with arrow 502. Computer unit 550 replies normally with an acknowledgement message to computer unit 580, as illustrated with arrow 503. However, at time t₂ there is a failure in computer unit 550. Therefore, due to a hardware or software failure computer unit 550 is no longer capable of answering or in the first place receiving the supervision message from computer unit 580 illustrated with arrow 504. Therefore, no acknowledgement message is sent. At time t₃ computer unit 580 determines that a timer has expired for acknowledging the supervision message illustrated with arrow 504. Therefore, computer unit 580 must take the role of the primary system management node. Therefore, it issues an address advertisement message to LAN switch 560 in a MAC frame as illustrated with arrow 505. LAN switch 560 observes that in the MAC frame is comprised the system management node physical address. Therefore, it knows that the system management node is now located in the LAN segment (not shown) of computer unit 580. Therefore all MAC frames with the destination address indicating the system management node physical address must be transmitted exclusively to the LAN segment from which the MAC frame was received. At time t₄ computer unit 570 performs a startup procedure and it therefore needs to obtain the logical name to MAC address mapping information of all relevant nodes. Therefore computer unit 570 issues an interrogation message, in other words an address resolution query message, which is encapsulated in a MAC frame the destination address of which is the management node physical address. The MAC frame is received by LAN switch 560, which transmits the MAC frame in the correct destination LAN segment. Therefore, computer unit 580, as illustrated with arrow 507, receives the MAC frame containing the interrogation message. Thereafter similar enquiries may originate from an arbitrary number of computer units. These are processed similarly. Further, an arbitrary functional computer unit may also assume a role of secondary system management node and start supervising the new primary system management node, that is, computer unit 580.

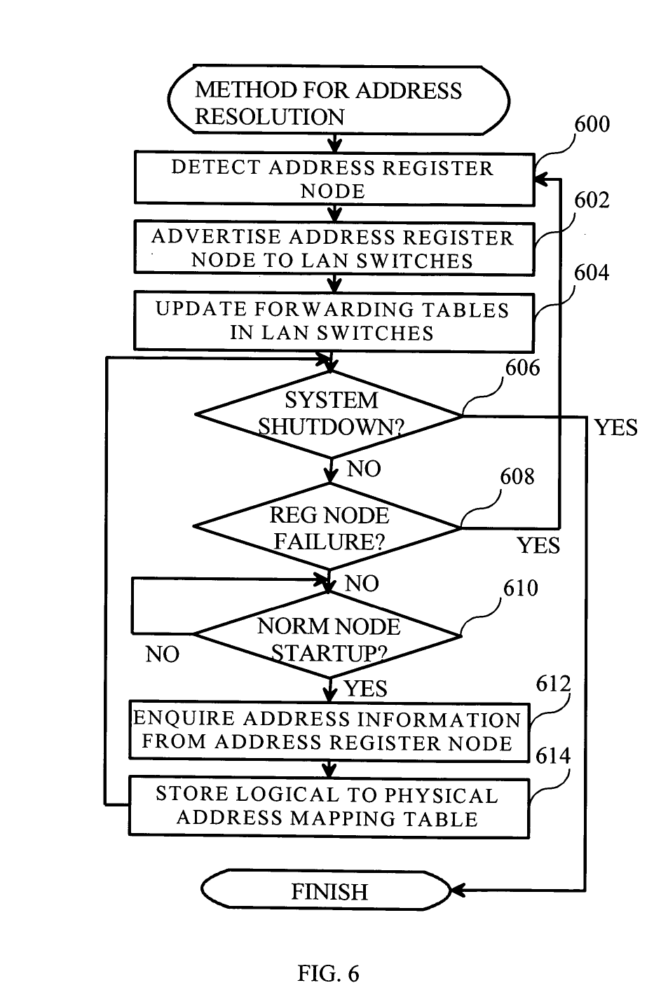

FIG. 6 is a flowchart illustrating a method for address resolution in one embodiment of the invention.

At step 600 a node detects that it is acting as an address register node. The address register node is equivalent to a system management node as illustrated in FIGS. 4 and 5. The fact that a node detects itself as an address register node may be based on an external indication or configuration information read by that node. An external indication is received, for example, in a case where a switchover has been performed between a primary system management node and a secondary system management node so that the secondary system management node takes the role of the primary system management node.

At step 602 the address register node advertises its unique system management node MAC address to at least one LAN switch. The advertisement may simply be a MAC frame wherein the source address is set to the system management node physical address. As a LAN switch receives the management node physical address it is able to determine the LAN segment, from which the MAC frame was originated. Therefore the LAN segment is connected to the system management node. This avoids the unnecessary transmitting of the MAC frame in other LAN segments.

At step 604 the forwarding tables in LAN switches are updated. As said this comprises the association of MAC addresses with LAN segments. The forwarding of the MAC frame carrying the advertisement may be stopped in the LAN switch. Therefore, the LAN switch acts as a destination for the advertisement instead of another computer node.

At step 606, in one embodiment of the invention, it is checked if system shutdown is being performed. If this is the case the method continues with shutdown procedures for the system management node and other nodes, which are not shown in FIG. 6. If it is not the case of system shutdown the method continues at step 608.

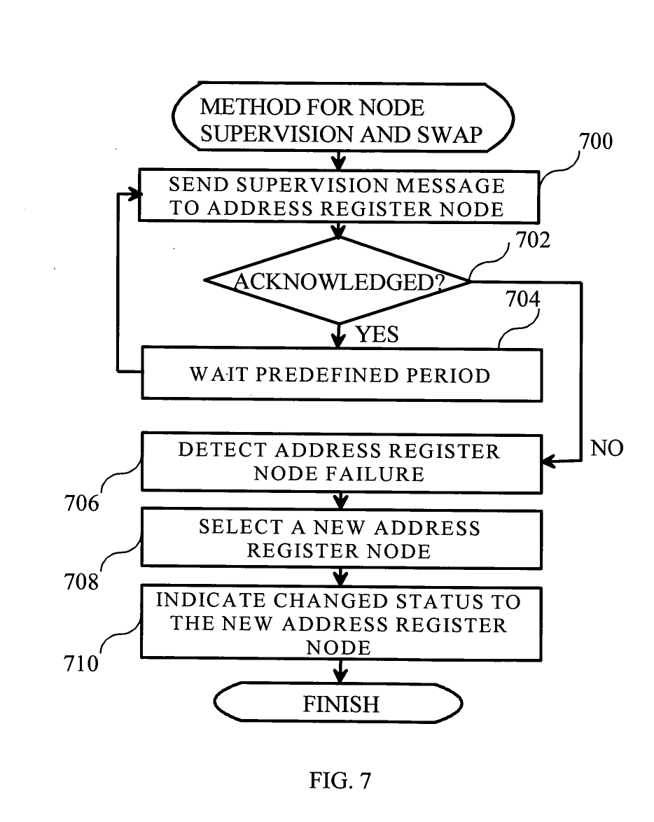

At step 608, in one embodiment of the invention, it is checked if the address register node has failed. A parallel process as illustrated in FIG. 7 raises the address register node failure status. If address register node failure status has been raised the method continues at step 600. If the register node failure status has not been raised the method continues at step 610.

The method continues at step 610 until a normal computer node performs startup procedure. In case of such startup procedure the method continues at step 612.

At step 612 the computer node performing the startup enquiries address information from the address register node that is the system management node. The computer node performing the startup sends an enquiry message to the system management node, which is encapsulated in a MAC frame. The address register node records from the enquiry the logical name of the node performing the startup and the source MAC address. The address register node adds to its memory an entry in which there is information that the logical name must be mapped to the source MAC address. The mapping entries form a table or any other similar data structure. The mapping table currently gathered by the address register node is returned by it to the computer node performing the startup procedure. The mapping table is returned in a reply message, which is encapsulated in a MAC frame.

At step 614 the normal node that performed the startup procedure stores the logical name to MAC address mapping table received from the system management node to its memory.

FIG. 7 is a flowchart illustrating a method for supervising a primary address register node and performing a switchover from a primary address register node to a secondary address register node in one embodiment of the invention.

At step 700 a supervision message is sent to the address register node, for example, from a secondary system management node or other node that performs the supervision of the primary system management node that performs the tasks of an address register node.

At step 702 it is checked if an acknowledgement message has been received within a specified time from the address register node, that is, the primary system management node. If no acknowledgement has been received the method continues at step 706. If an acknowledgement has been received the method continues at step 704.

At step 704 a timer is started and upon the expiry of the timer the method continues at step 700 where the sending of the supervision message is repeated.

At step 706 a failure of the address register node is detected. The failure may be a software failure or a hardware failure, which causes, that a computer unit being supervised is unable to acknowledge a supervision message within a specified time.

At step 708 a new address register node is selected. The selection is based on, for example, a list of node MAC layer addresses in a predefined order. The first MAC address is selected from the list. It should be noted that a system management node recognizes two addresses on the MAC layer. The first is the unique system management node physical address, which has been pre-configured to all computer nodes within the system. The second MAC layer address is a MAC address specific to that particular computer unit. That address is used whenever that computer node is addressed as a computer unit in normal mode, in other words, when it is not acting as the primary system management node.

At step 710 the changed status is indicated to the new address register node that has just been selected. Based on the status indication the address register node detects itself as the system management node as described in the context of step 600 in FIG. 6.

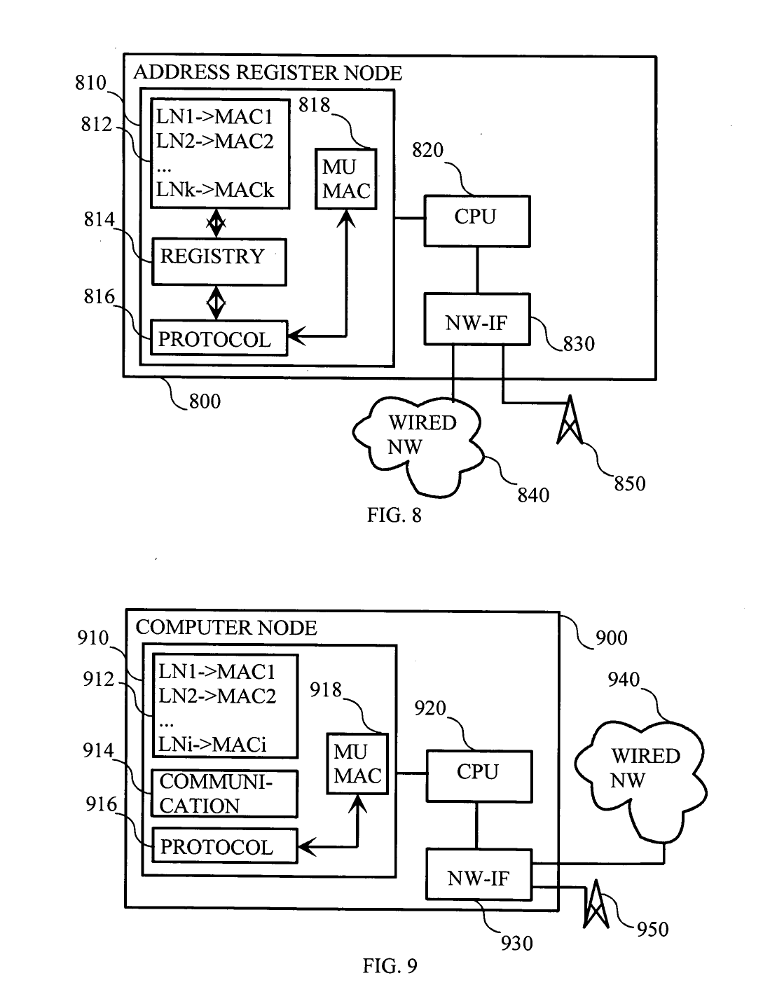

FIG. 8 is a block diagram illustrating an address register node in one embodiment of the invention.

In FIG. 8 there is a computer node 800, which acts as an address register node, that is, a primary system management node. In computer node 800 there is at least one CPU 820, a network interface 830 and a memory 810. Memory 810 stores a mapping table 812, which is used in the mapping between logical names and MAC layer addresses. At least part of the mapping table is returned to an enquiring normal mode network node in response to an address resolution query message or to an address information message. There is also a registry entity 814, which reads and writes the mapping table 812. Registry entity 814 communicates with a protocol entity 816. To the network interface 830 may be connected a wired network 840 or a base station 850 for a wireless network segment. Mapping table 812 contains altogether k number of different logical name and MAC layer address pairs. Variable k represents an arbitrary integer. The logical names may be, for example, IP addresses or logical computer unit names or arbitrary layer-3 addresses.

FIG. 9 is a block diagram illustrating a computer node in one embodiment of the invention. In FIG. 9 there is a computer node 900. The computer node is in normal mode according to the method of the invention. Computer node 900 comprises a CPU 920, a network interface 930 and a memory 910. The memory comprises a mapping table 912 between logical addresses and physical layer addresses. The mapping table has been obtained from an address register node in response to an address resolution query message. The mapping table contains the logical address and physical address pairs that were collected by the address register node up to the point when the address resolution query message was received by it from computer node 900. Mapping table 812 contains altogether i number of different logical name and MAC layer address pairs. The variable i represents an arbitrary integer. Memory 910 also comprises a communication entity 914 and a protocol entity 916. The entities 914 and 916 may be software entities such as program blocks procedures, modules or subroutines. They may be executed as separate processes or threads or they may be executed in a single process or thread and they may be also executed as part of operating system kernel. To network interface 930 may be connected a wireless LAN base station for communicating in a wireless LAN. To the wireless LAN may be further communicating a LAN switch which is equipped with a wireless base station. To network interface 930 may be connected a wired network 940. The wired network may be an Ethernet, an ATM network, a SDH/SONET network. The wired network may be based on coaxial cable or optical fibers. The list of network technologies is not exhaustive.

The entities within address register node 800 in FIG. 8, in other words the system manager node, such as protocol entity 816 and registry entity 814 may be implemented in a variety of ways. The same is true concerning protocol entity 916 and communication entity 914 within computer node 900 in FIG. 9. They may be implemented as processes executed under the native operating system. The entities may be implemented as separate processes or threads or so that a number of different entities are implemented by means of one process or thread. A process or a thread may be the instance of a program block comprising a number of routines, that is, for example, procedures and functions. Entities 814, 816 may be implemented as separate computer programs or as a single computer program. The program blocks are stored on at least one computer readable medium such as, for example, a memory circuit, memory card, magnetic or optic disk. Some entities may be implemented as program modules linked to another entity. The computer readable medium may also be connected to another computer unit, which acts as a proxy for address register node 800 or computer node 900 when reading or writing data to the computer readable medium.

The entities such as entities 814 and 816 may also be stored in separate memories and executed by separate processors, which communicate, for example, via a message bus or an internal network. An example of such a message bus is the Peripheral Component Interconnect (PCI) bus. For example, the protocol entity 816 may be implemented on a separate network interface card in association with address register node 800. The system management node physical address may also be configured to a separate memory within a network interface card.

Address register node 800 or computer node 900 may also, for example, be desktop computers, workstations, laptop computer, palmtop computers or other portable computers. Address tables 812 and 912 may be stored, for example, in a data structure such as a table, a tree structure or a hash table in memories 810 and 812, respectively.

It is obvious to a person skilled in the art that with the advancement of technology, the basic idea of the invention may be implemented in various ways. The invention and its embodiments are thus not limited to the examples described above; instead they may vary within the scope of the claims.

1. A method for address resolution in a communication system comprising
configuring a management node physical address in a first node and a second node;
said first node detecting that it must act as a management node;
transmitting said management node physical address from said first node to a switch via a first network segment;
associating said management node physical address with said first network segment in said switch;
transmitting an address resolution query message from said second node via a second network segment to said switch, said address resolution query message comprising said management node physical address, a logical address of said second node and a physical address of said second node;
said switch transmitting said address resolution query to said first network segment;
said first node recording an association between said logical address of said second node and the physical address of said second node; and
said first node providing to said second node information on at least one association between a physical address and a logical address of a third node.

2. The method according to claim 1, the method further comprising:
periodically checking a status of said first node by a third node;
detecting a failure of said first node;
selecting a fourth node to become a management node; and
requesting said fourth node to enter a management node state.

3. The method according to claim 1, the method further comprising:
determining, in a maintenance unit, that said first node is to become a management node; and
requesting, from said maintenance unit, said first node to enter a management node state.

4. The method according to claim 1, the method further comprising:
said first node reading a configuration memory to check whether the first node must enter a management node state.

5. The method according to claim 1, wherein said first or second network segment is an Ethernet segment, said switch is an Ethernet switch and said physical address is a medium access control address.

6. The method according to claim 1, wherein said first or second network segment comprises a wireless network segment.

7. The method according to claim 1, wherein said communication system is comprised in a blade server and said first node and second node are computer units within said blade server.

8. The method according to claim 1, wherein said logical address is a logical name identifying a computer unit within a network element comprising at least two computer units.

9. The method according to claim 8, wherein said network element comprises at least one of a Global System of Mobile Communications network element and a Universal Mobile Telephone System network element.

10. The method according to claim 8, wherein said network element comprises at least one of a Mobile Switching Center, Mobile Switching Center Server and a Call State Control Function.

11. A system comprising:
a first node configured to store a management node physical address, to detect that it must act as a management node, to transmit said management node physical address to a switch via a first network segment, to record an association between a logical address of a second node and a physical address of said second node, and to provide to said second node information on at least one association between a physical address and a logical address;
said switch configured to associate said management node physical address with said first network segment and to transmit an address resolution query to said first network segment; and
said second node configured to store a management node physical address, to transmit said address resolution query message via a second network segment to said switch, said message comprising said management node physical address, a logical address of said second node and a physical address of said second node.

12. The system according to claim 11, the system further comprising:
a third node configured to check periodically the status of said first node, to detect a failure of said first node, to select a fourth node to become a management node and to request said fourth node to enter a management node state.

13. The system according to claim 11, the system further comprising:
a maintenance unit configured to determine that said first node is to become a management node and to request said first node to enter a management node state.

14. The system according to claim 11, the system further comprising:
said first node configured to read a configuration memory to check whether the first node must enter a management node state.

15. The system according to claim 11, wherein said network segment is an Ethernet segment, said switch is an Ethernet switch and said physical address is a medium access control address.

16. The system according to claim 11, wherein said network segment comprises a wireless network segment.

17. The system according to claim 11, wherein said system is comprised in a blade server and said first node and second node are computer units within said blade server.

18. The system according to claim 11, wherein said logical address of said second node is a logical name identifying a computer unit within a network element comprising at least two computer units.

19. The system according to claim 18, wherein said network element comprises at least one of a Global System of Mobile Communications network element and a Universal Mobile Telephone System network element.

20. The system according to claim 18, wherein said network element comprises at least one of a Mobile Switching Center, Mobile Switching Center Server and a Call State Control Function.

21. A network node comprising:
a memory configured to store a management node physical address; and
a processor configured to detect that said network node must act as a management node, to transmit said management node physical address via a network segment, to receive an address resolution query message, to record in said memory an association between a logical address of a second node and the physical address of said second node from said address resolution query message, and to provide from said memory to said second node information on at least one association between a physical address and a logical address in response to said address resolution query message.

22. A network node comprising:
a memory configured to store a management node physical address; and
a processor configured to transmit an address resolution query message via a network segment, said address resolution query message comprising said management node physical address as a unicast destination address, a logical address of the network node and a physical address of the network node, to receive information on at least one association, each association comprising a physical address and a corresponding logical address, and to record in said memory said information on said at least one association.

23. A network node comprising:
means for storing a management node physical address;
means for detecting that said network node must act as a management node;
means for transmitting said management node physical address via a network segment;
means for receiving an address resolution query message;
means for recording in said memory an association between a logical address of a second node and the physical address of said second node from said address resolution query message; and
means for providing from said memory to said second node information on at least one association between a physical address and a logical address in response to said address resolution query message.

24. A network node comprising:
means for storing a management node physical address;
means for transmitting an address resolution query message via a network segment, said message comprising said management node physical address as a unicast destination address, a logical address of the network node and a physical address of the network node;
means for receiving information on at least one association, each association comprising a physical address and a corresponding logical address; and
means for recording in said memory said information on said at least one association.

25. A computer program comprising code adapted to perform the following steps when executed on a data-processing system:
storing a management node physical address;
detecting the need to assume the role of a management node;
transmitting said management node physical address via a network segment;
receiving an address resolution query message;
recording an association between a logical address of a node and the physical address of said node from said address resolution query message; and
providing information on at least one association between a physical address and a logical address in response to said address resolution query message.

26. The computer program according to claim 25, wherein said computer program is stored on a computer readable medium.

27. The computer program according to claim 26, wherein said computer readable medium is a removable memory card.

28. The computer program according to claim 26, wherein said computer readable medium is a magnetic or an optical disk.

29. A computer program comprising code adapted to perform the following steps when executed on a data-processing system:
reading a management node physical address from a memory of a network node;
transmitting an address resolution query message via a network segment, said address resolution query message comprising said management node physical address as a unicast destination address, a logical address of the network node and a physical address of the network node;
receiving information on at least one association, each association comprising a physical address and a corresponding logical address; and
recording, in the memory of the network node, said information on said at least one association.

30. The computer program according to claim 29, wherein said computer program is stored on a computer readable medium.

31. The computer program according to claim 30, wherein said computer readable medium is a removable memory card.

32. The computer program according to claim 30, wherein said computer readable medium is a magnetic or an optical disk.
